(19) United States
(12) Patent Application Publication
(10) Pub. No.: US 2008/0051158 A1
(43) Pub. Date: Feb. 28, 2008

(54) Galvanic isolation integrated in a signal channel

(75) Inventors: Barry Jon Male, West Granby, CT (US); Steven Hemmah, Goffstown, NH (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED

(21) Appl. No.: 11/507,999

(22) Filed: Aug. 22, 2006

(51) Int. Cl. H04B 1/38

(52) U.S. Cl. 455/572

(57) ABSTRACT

A communication link between two isolated electrical devices provides for adjustable impedances coupled to the communication link signal paths to balance the signal paths and improve CMRR. The communication link may be a bidirectional capacitively coupled differential signal line to improve noise rejection. The capacitance may be realized as portions of circuit board traces, lead frames, IC pins and/or molding on ICs or on an IC package. The variable impedance compensates for variances in the capacitive coupling values so that the signal paths react similarly in the presence of noise or interference. The variable impedance may be set or programmed from stored values that may be digital or analog. The capacitive coupling of the differential signal line permits integration of isolated devices in a common package.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

1. Field of the Invention

The present invention relates generally to isolation issues between power equipment and devices and digital control equipment and devices, and relates more particularly to isolation in a signal link between an electronic power device and an electronic control device.

2. Description of Related Art

In a number of electronic systems, control functions are provided by low-power, often discrete circuitry that is isolated from high-power circuitry. The isolation can be provided according to many different techniques, especially considering the application a circuit designer has in mind. In one typical application, digital control circuitry communicates with high-power circuitry through an isolated signal or communication link. When the high-power circuitry defines a power supply, high-voltage electrical isolation may typically be used. Common practices and regulations often require high-voltage electrical isolation from earth ground for the power supply system.

One situation in which a digital control communicates with a high-voltage electrically isolated power supply is in Power over Ethernet (PoE) applications. In such an application, Power Source Equipment (PSE) typically supplies power over network links, typically from a network switch location. A power supply coupled to the switch or various network lines distributes supply power to connected equipment in the network that are PoE compliant. Control of the power distributed over the network represents a challenge due to the numerous applications or situations that may occur in a network, and also because of power line events, such as short circuits, over-voltage conditions and so forth. One particular challenge is to provide communication between the electrically isolated high-voltage power supply and a low-voltage digital control that is referenced to earth ground to obtain a robust and high-performance electrical distribution system control.

Power distribution in a PoE system usually stems from an electrically isolated 48V power supply that is isolated from earth ground in accordance with IEEE 802.3. A local controller for the supply power, such as may be used for a single port of an Ethernet switch, is also electrically isolated from earth ground. The supply controller manages power supplied over an Ethernet link, for example, in accordance with preset parameters, algorithms or commands that may be provided in the power controller, or communicated to the controller over an isolated communication link. Optionally, discrete signals may be supplied directly from an earth ground referenced digital controller to the power controller, again with high-voltage electrical isolation between the digital controller and the power controller. The power controller itself is typically a DC-DC converter that switches an input DC power supply to produce a regulated 48V electrically isolated output to the network link.

Isolation between the digital controller and the power controller is typically realized through optical or magnetic devices that represent several drawbacks in achieving a PoE solution. For example, the optical or magnetic devices are typically bulky, costly, have high power dissipation and degradation problems over time. The optical or magnetic devices are also typically separate devices, so that an integrated solution is not available with these devices.

### BRIEF SUMMARY OF THE INVENTION

In accordance with the present invention, there is provided a signal link between a high-voltage isolated power controller and an earth ground referenced digital controller using a differential capacitive approach. The high-voltage isolation can be integrated into a number of different parts of the signal link path, including mechanical device assemblies or subassemblies of the digital controller or power controller.

According to an exemplary embodiment, the isolation is provided on one or more of a network link module, a printed circuit board that couples the digital controller to the power controller, or on the integrated circuit lead frame of the power controller itself. These isolation techniques can use mechanical assemblies that already provide insulating material for high-voltage isolation for the signal link between the digital controller and the power controller.

According to an exemplary embodiment, the digital controller and the power controller are provided on separate ICs, which are coupled with isolated signal links. The ICs or mechanical interconnections between the ICs may be used to provide the desired isolation with differential capacitive components. For example, the IC pins may be used to contribute to providing the isolation mechanism. The circuit board traces on which the ICs may be mounted may also be used to produce the isolation structures desired. If the ICs have direct wiring connections without a circuit board, the wire connections themselves may be configured to provide the isolation structure. Indeed, any type of structure located proximate to the signal links coupling the digital controller and the power controller may be configured to obtain the structure and desired isolation in accordance with the present disclosure. Discrete high-voltage capacitors may also be used to achieve the isolation structure presently disclosed.

According to an exemplary embodiment, the isolation structure includes differential capacitances to promote signal integrity. To overcome manufacturing or operational tolerances leading to capacitive value mismatches, a system and method for compensating relative capacitive values is provided. Capacitive value mismatch can lead to poor AC Common Mode Rejection Ratio (CMRR), which reduces circuit performance and reliability, especially in the presence of noise or interference. In addition, manufacturing processes can introduce parasitic effects leading to stray capacitances, which can also be compensated to obtain balanced signal line operation for improved signal integrity and system performance.

According to an aspect of the disclosed system and method, CMRR tuning to balance differential signal line operation is conducted during manufacturing of an assembly or subassembly of the digital and power controllers. Alternately, CMRR tuning is active, and may be conducted at certain intervals or intermittently, such as when a device is powered up, for example.

According to another aspect, the disclosed system and method compensates relative capacitance with the use of stored value related to a circuit variable that adjusts relative capacitance compensation. For example, the desired adjustment may be stored digitally and provided to the circuit variable upon power-up. The stored value may also be adjusted dynamically to accommodate changes to circuit operational parameters that may occur over time. For example, circuit parameters may change with component degradation or due to environmental conditions such as variable temperature ranges. Alternately, or in addition, the adjustment value may be stored as an analog value, such as by placing a specific charge on a capacitor to produce a voltage that may be used to compensate the relative capacitive value in the isolation structure. The adjustment value may be continuously updated, or updated at specific intervals such as when transmitting a signal on the signal link, for example, or during power-up.

### BRIEF DESCRIPTION OF THE DRAWINGS

The disclosed system and method is described in greater detail below with a preference to the accompanying drawings, in which:

FIG. 1 is a block diagram of a Power over Ethernet (PoE) system configuration;

FIG. 2 is a schematic block diagram illustrating port connections for a PoE application;

FIG. 3 is a schematic block diagram of an isolated communication channel; and

FIG. 4 is a schematic block diagram of an isolated communication channel provided within a single integrated circuit package.

### DETAILED DESCRIPTION OF THE DRAWINGS

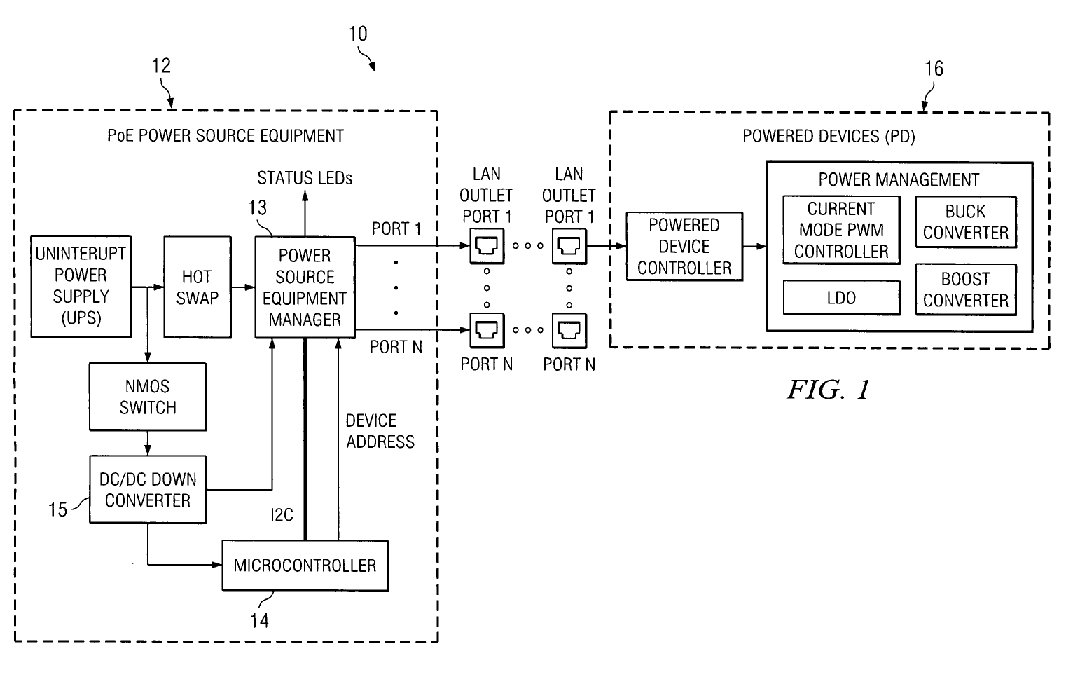

Referring now to FIG. 1, a Power over Ethernet (PoE) system 10 illustrates architecture of Power Source Equipment (PSE) 12 and Powered Devices (PD) 16. PSE 12 includes a microcontroller 14 that controls PSE manager 13. A DC/DC converter 15 supplies power to PSE manager 13 for delivery to ports 1-n. The power delivered to ports 1-n is typically a 48V supply that is isolated for safety and implementation reasons. Microcontroller 14 communicates with PSE manager 13 to deliver instructions or parameters to PSE manager 13, and to receive data or feedback from PSE manager 13. Microcontroller 14 is typically referenced to a digital ground that is usually an earth ground to provide a consistent basis for digital logic operations. The communication link between microcontroller 14 and PSE manager 13 is similarly referenced to digital ground. Accordingly, PSE manager 13 provides an isolated communication link between the communication link interface from microcontroller 14 and the power control components that supply the isolated power to ports 1-n.

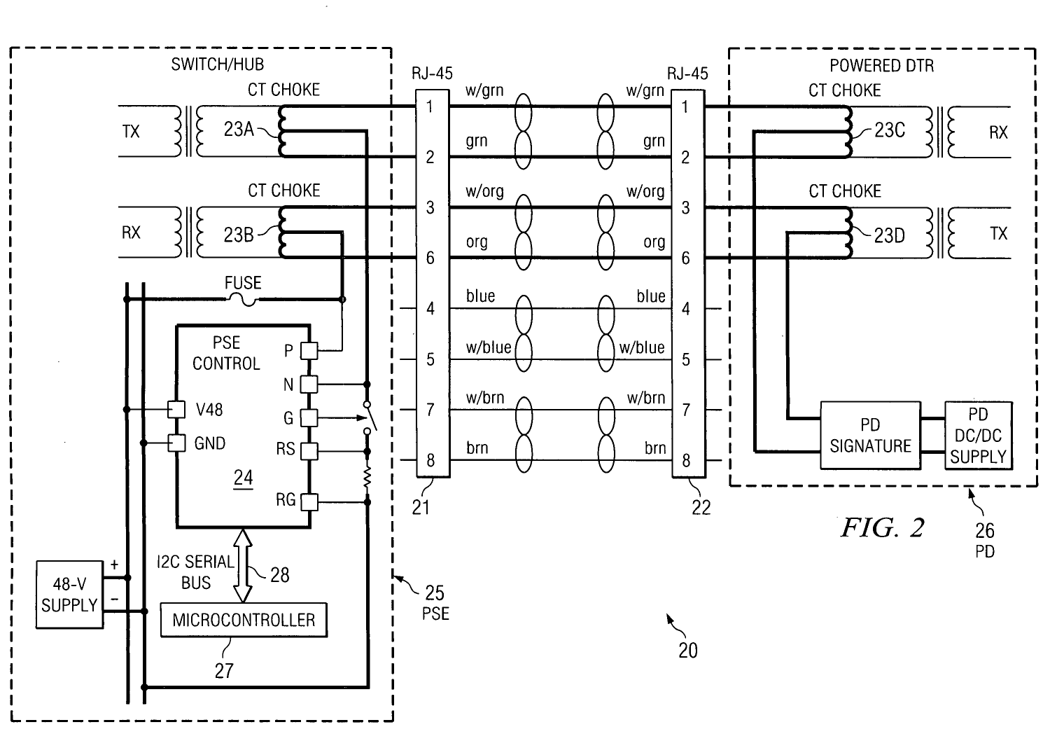

Referring now to FIG. 2, a schematic block diagram 20 illustrates a technique for transferring power over an Ethernet connection. The Ethernet connection is between RJ45 connectors 21-22, and uses center tapped chokes or inductors 23A-23D to transfer power between a PSE 25 and a PD 26. PSE 25 includes a PSE controller 24 coupled to a microcontroller 27 over a communication link 28. Communication link 28 is illustrated as an I2C serial bus, but can consist of any type of communication link, including discrete I/O lines. Microcontroller 27 is referenced to a digital ground to provide a common reference for digital electronics to implement the logic and control functions used to help operate PSE controller 24. PSE controller 24 receives instructions and parameters from microcontroller 27, for example, and may also transmit information to microcontroller 27 related to power supply conditions. For example, microcontroller 27 may set a current limit for power output controlled by PSE controller 24, where the current limit may be stored in memory in PSE controller 24. Similarly, PSE controller 24 may deliver feedback information concerning power supply information to microcontroller 27.

The information transferred over communication link 28 passes through an isolation barrier so that PSE controller 24 can maintain an isolated power supply for the PoE system. In previous configurations, the barrier was constructed to provide optical isolation, or magnetic isolation for the signals that passed between microcontroller 27 and PSE controller 24. These types of isolation configurations tend to be somewhat bulky and expensive to implement, especially in PSE 25, where space on circuit boards located near Ethernet ports is at a premium. In addition, the previous optical or magnetic isolation configurations were typically separate from PSE controller 24 and microcontroller 27, leading to challenges in circuit board configurations to accommodate the separate components.

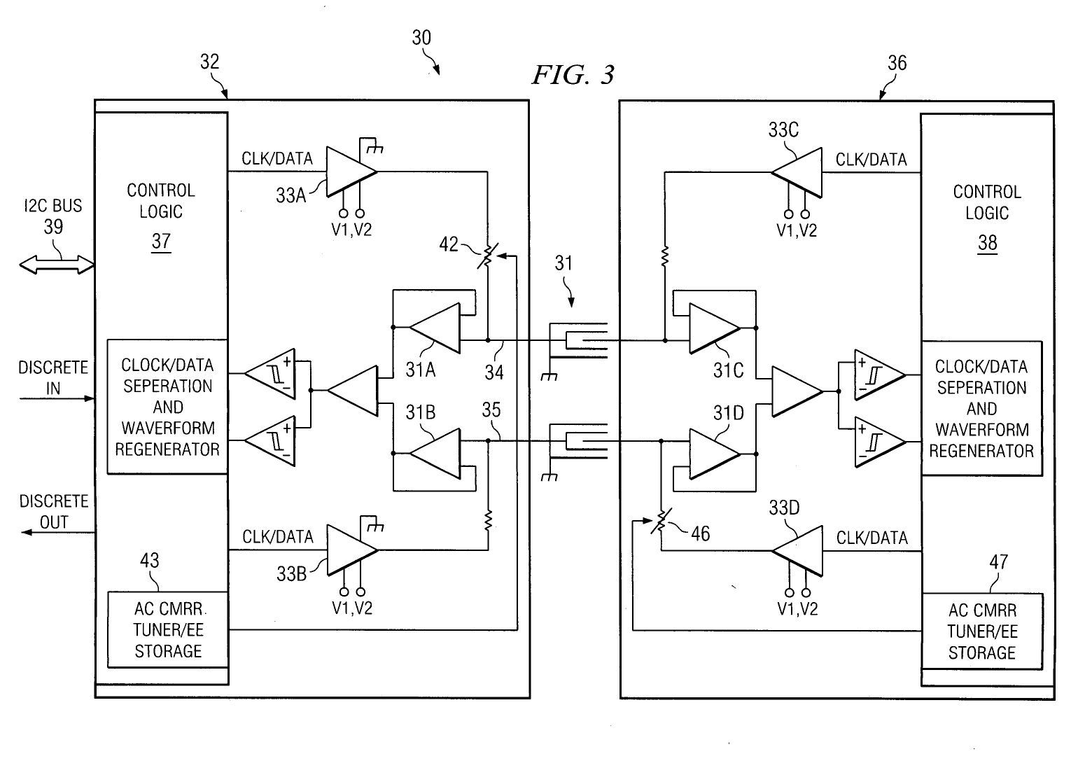

Referring now to FIG. 3, a block diagram of an isolated communication link 30 illustrates an isolated connection between an interface 32 for ground reference signals and an interface 36 for isolated PoE control. Communication link 30 provides high-voltage electrical isolation for the PoE power system from earth ground. Communication link 30 is illustrated as a serial link 31, but can be composed of individual discrete signals and other signal transfer arrangements. Serial link 31 is a differential communication link, in which transmitters and receivers are connected with two signal lines that provide signaling with a differential signal. That is, the transmitters 33A-33D produce a voltage difference with respect to differential signal lines 34, 35. The voltage differential signal has a relatively high immunity to commonly experienced noise or interference, for high communication information integrity. In one embodiment, transmitters 33A-33D produce high-speed complementary pulses that travel across lines 34 35. Receivers 31A-31D receive the differential signal and contribute to converting the voltage difference to an interface referenced signal, according to the respective reference of interface 32 or 36. Control logic 37, 38 translates the series of pulses produced from the differential voltage signal to information formatted for a particular interface. For example, control logic 37 converts the pulses derived from receivers 31A, 31B to data formatted for I2C bus 39 or other signals output from control logic 37. Similarly, control logic 37 converts data formatted from I2C bus 39 and other discrete inputs into a form usable by transmitters 33A and 33B to send information over serial link 31. In one embodiment, control logic 37 produces signals for transmitters 33A, 33B that are a hybrid combination of clock and data information suitable for multi-level differential transmission. Various protocols or information architectures may be used to convert the digital ground referenced signals to differentially transmitted signals, and vice versa. Control logic 38 operates similarly to control logic 37, with the interface being coupled to control components for the PoE power supply equipment.

Communication link 30 has the advantage of being implemented in a small area, and even integrated into an IC. Accordingly, communication link 30 can greatly reduce the amount of space used for isolation of the PoE power supply from ground referenced electronics. In addition, communication link 30 permits the possibility of implementing a communication link in a PSE controller, such as PSE controller 24.

One aspect of communication link 30 that contributes to improving the signal integrity is the impedances associated with each signal line 34, 35. The quality of the differential signal between lines 34, 35 is greatly improved if the impedances of the lines substantially match each other, or are balanced. Typically, capacitances associated with signal lines 34, 35 should be balanced within a certain tolerance to promote high differential signal integrity. However, it is difficult in practice to produce capacitive values that are balanced for lines 34, 35, particularly when interfaces 32, 36 are implemented in ICs. For example, manufacturing tolerances or parasitic elements contribute to produce poor matching between capacitive values associated with lines 34, 35. Various other factors may impact the capacitive matching, including temperature variations and component deterioration over time, for example. In an environment that includes both control and power signals, impedance matching can be critical to the operation of communication link 30 to reject noise and interference that can impact communication data integrity. This concept is often quantified with a Common Mode Rejection Ratio (CMRR). The CMRR refers to the ability of differential signal lines 34, 35 to reject noise and interference that is common to both lines. That is, noise or interference experienced by both differential signal lines 34, 35 should have a small impact on data integrity for a high CMRR. If one of signal lines 34, 35 were to react differently than the other in the presence of noise, data integrity would be at greater risk. Accordingly, balance of impedances or capacitive loads on signal lines 34, 35 contribute to maintaining a high CMRR by providing a consistent response for both signal lines 34, 35 in the presence of noise or interference.

In accordance with the present invention, impedance tuning devices are provided for signal lines 34, 35. Interface 32 includes a tuning device illustrated as a variable resistor or potentiometer 42, while interface 36 has a variable resistor or potentiometer 46. Interface 32 also includes a device for setting the adjustment of variable resistor 42, in the form of a parameter storage 43. Similarly, interface 36 includes a device for storage of values pertaining to adjustment of variable resistor 46 in a parameter storage 47. By setting the value of variable resistors 42, 46, lines 34, 35 can be balanced to obtain a high CMRR. Resistors 42, 46 operate in conjunction with parasitic or specified capacitances to obtain an RC circuit that produces a time constant, that can be matched for lines 34, 35. It should be apparent that other types of impedance matching may also take place for lines 34, 35, including inductive, capacitive and resistive.

With resistors 42 or 46 compensating parasitic or specified capacitances, a number of advantages emerge for producing specific capacitance values for use in forming differential communication link 31. For example, the capacitive values may be obtained through configuration of lead frames for the final assembly of interconnection between interface 32 and 36. When interface 32 and 36 are located on a printed circuit board, for example, other component configurations may be used to achieve the desired capacitance. For example, the traces of the printed circuit board may be configured to obtain a desired capacitive value for differential signal lines 34, 35. When interfaces 32, 36 are packaged together in a single IC package, interconnections between interface 32, 36 may be configured to obtain the desired capacitances. In addition, the packaging itself may be configured to produce the desired capacitive elements. IC pins may also be used to obtain the desired capacitance values for lines 34, 35. In addition, discrete high voltage capacitors may be used to obtain the capacitive values desired.

In each of the cases described above for realizing the capacitive values associated with differential signal lines 34, 35, the capacitive value can be established with a certain range of tolerance that lends itself to simple manufacturing techniques. Adjustments made to resistors 42 or 46 overcome mismatches of capacitive values to balance signal lines 34, 35. Accordingly, as long as the capacitance values associated with signal lines 34, 35 are within a particular range, resistors 42 or 46 can be used independently or in combination to achieve a balanced impedance for signal lines 34, 35. Accordingly, variable resistances 42, 46 permit the AC CMRR to be tuned to compensate capacitance mismatch and parasitic effects due to manufacturing mechanical tolerances and application influences.

Communication link 30 transmits data across the isolation barrier by coupling high-speed, complimentary pulses through a high voltage low value capacitance. As discussed, the capacitance may be obtained in a connector lead frame, IC package lead frame, printed circuit wiring or trace patterns, circuit board modules, IC packages and so forth. Receivers 31A-31D restore pulses to logic levels referenced to interface 32 or 36, respectively. The differential signal transmission using complimentary pluses rejects high slew rate and common mode voltage transients. In the presence of wildly varying common mode signals across the isolation barrier, data corruption can occur if the differential circuit cannot properly reject the common mode noise. Previous approaches obtained poor AC CMRR due to capacitor mismatch, often because of molding compound non-uniformity and capacitor plate manufacturing tolerances. By tuning variable resistors 42, 46, a very high CMRR can be achieved for receivers 31A-31D. Receivers 31A-31D receive and extract clock and data information according to a particular protocol. Interface 32 translates the extracted clock and data information into various standard signals, such as those used by an I2C bus, as well as other discrete signals such as discrete I/O. Discrete signals may include high priority signals such as interrupt and shutdown signals, for example. The high-speed capacitive coupling of differential signal link 31 eliminates excessive power usage associated with opto-couplers that are often used in isolation environments, and avoids other long-term issues associated with opto-couplers, such as long term degradation of opto-coupler photo emission.

The construction of communication link 30 may be implemented in a number of forms to obtain the differential capacitance used to realize differential signal link 31. In an exemplary embodiment, differential capacitors are constructed within copper patterns of a PC board assembly. The dielectric capabilities of the epoxy PC board layers provides high-voltage isolation. Usually, the high-voltage isolation is many thousands of volts.

In another exemplary embodiment, the differential capacitance may be realized through a connector assembly in which a PC board is eliminated. For example, a direct die and wire bond assembly of various ICs and inductors form the interconnect structure to achieve the differential capacitance desired. The lead frames of the various ICs can form the plates for the differential capacitors in this approach. The assembled unit is injection molded to form a fully integrated RJ45 connector assembly, for example.

In another exemplary embodiment, the capacitive values are realized for the differential transceiver as part of the IC package using a molding compound that forms the package dielectric barrier. The dielectric barrier again provides a high level of voltage isolation, and can be adjusted in rough terms to obtain desired capacitive values for the differential communication link.

In any particular embodiment of the present invention, variations in capacitance associated with signal lines 34, 35 can be compensated using variable resistors 42, 46, either alone or in cooperation with each other. Adjustment of variable resistors 42, 46 produce a time constant in conjunction with the differential capacitance that is matched across signal lines 34, 35, thereby compensating any variations in capacitive values between signal lines 34, 35. Variable resistors 42, 46 can be adjusted independently or in concert to provide a wide range of adjustment and cover a large range of capacitive tolerances provided in the construction of communication link 30.

Parameter storages 43, 47 store values for adjusting variable resistors 42, 46 to balance lines 34, 35. Storages 43, 47 may be in the form of electrically erasable storage, such as EEPROM or other types of resetable digital storage. The parameter values produced by storage 43, 47 can be used to provide offsets or tuning for resistors 42, 46 to obtain balanced differential lines 34, 35. By providing an adjustment to variable resistors 42, 46, parameter storage 43, 47 can adjust or tune the CMRR to significantly improve signal integrity and performance for serial link 31. Alternately, or additionally, parameter storage 43, 47 may be analog, such as may be implemented with a capacitor storage value. In such a configuration, a voltage stored on a capacitor in interfaces 32, 36 provides an indication for setting a value or an offset to variable resistors 42, 46. A capacitor with such a charge value may be used to directly provide a voltage offset to variable resistors 42, 46, or may simply be read to obtain an indication of what the adjustment for variable resistors 42, 46 should be to obtain balanced serial link 31.

Tuning the CMRR of communication link 30 can be achieved in a number of different ways. For example, the tuning may be achieved on a one-time basis, such as when communication link 30 is under test during manufacture. In such an instance, a test signal may be provided across serial link 31, such that any unbalance in the impedance of lines 34, 35 results in a voltage observed with respect to one of lines 34, 35. The appropriate variable resistor 42, 46 is then tuned or set to a particular value to null out the induced voltage. The tuning may also take place on an intermittent basis, for example when communication link 30 is powered up. In such an exemplary embodiment, variable resistors 42, 46 are adjusted whenever power is first supplied to communication link 30. The technique for tuning the resistors may be the same as that for a test situation described above, in which a test voltage is applied to lines 34, 35, and any AC voltage offset is nulled through adjustment of variable resistors 42, 46. Resulting tuning variables may then be stored in parameter storage 43, 47 and used for a length of time that communication link remains powered.

In another exemplary embodiment, communication link 30 may be continuously tuned through continuous testing of an AC offset voltage on lines 34, 35, such as during periods when serial link 31 is inactive, and the values for variable resistors 42, 46 can be updated. Again, any adjustment or offset values provided to variable resistors 42, 46 can be stored in parameter storage 43, 47 on a continuous basis.

In another exemplary embodiment, a feedback loop can be created to test for any AC offset voltage on lines 34, 35 that exceeds a specified threshold. The threshold would be related to a desired CMRR value that would contribute to ensuring signal integrity for signals crossing serial link 31. Once an AC offset voltage for lines 34, 35 exceeded the specified threshold, a recalibration of the values or offsets for variable resistors 42, 46 may be made as described above.

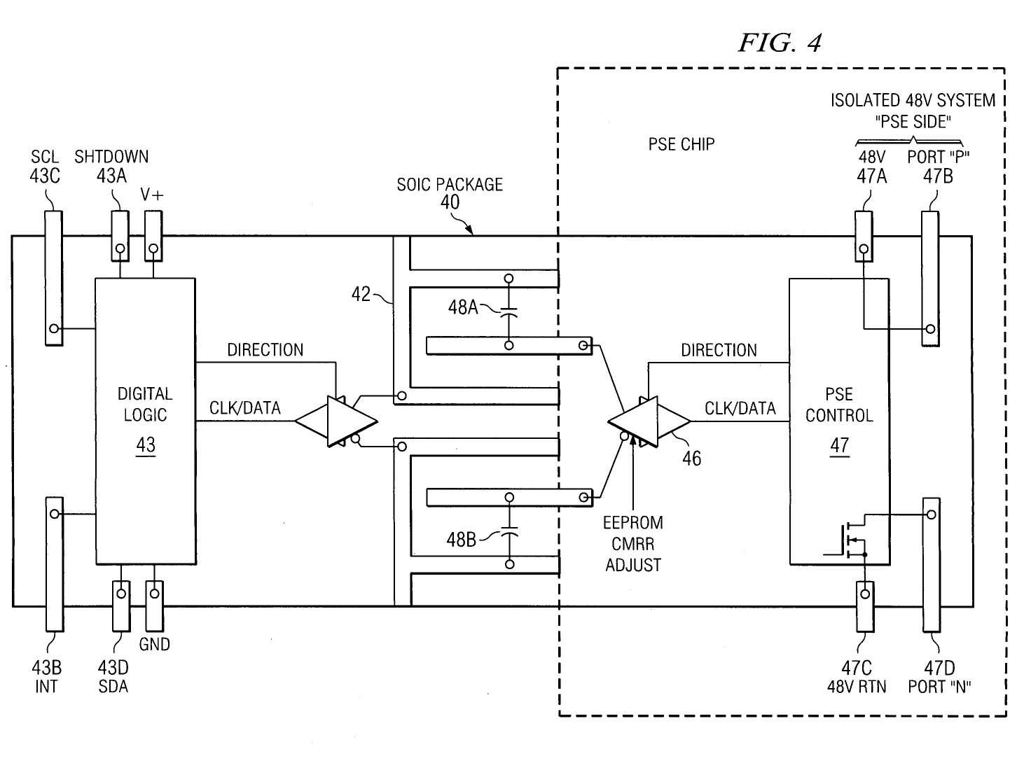

Referring now to FIG. 4, a diagram of the architecture of an IC package 40 shows an implementation of an isolated serial link 42 in a single package. IC package 40 includes transceivers 41, 46 and interface controllers 43, 47 that communicate over serial link 42. Interface 43 provides a ground referenced interface with other digital logic systems, such as through discrete lines 43A, 43B or bus lines 43C, 43D. Controller 43 provides logic to convert the clock and data information from transceiver 41 to digital logic signals suitable for use with connections 43A-43D. Controller 43 also provides conversion between signals on lines 43A-43D to clock and data representations for transmission on serial link 42. Controller 47 similarly translates clock and data information from transceiver 46 to support control of lines 47A-47D. Controller 47 also supplies information and data back to controller 43 through serial link 42 by translating various parameter data into clock and data information suitable for transmission over transceiver 46 and serial link 42.

Controller 47 and transceiver 46 are floating with respect to controller 43 and transceiver 41 to provide high-voltage isolation for the power supply controlled by controller 47. Controllers 43 and 47 are located within a package 40, and the realization of capacitors 48A, 48B may be achieved through lead frames, pin connections, trace layout, package characteristics such as molding, and so forth. Because the communication with the isolated power supply controller can be integrated into a single package, a significant savings and space, power, manufacturing costs and other advantages may be achieved.

Although the present invention has been described in relation to particular embodiments thereof, other variations and modifications and other uses will become apparent to those skilled in the art from the description. It is intended therefore, that the present invention not be limited by the specific disclosure herein, but to be given the full scope indicated by the appended claims.

What is claimed is:

1. A system for transferring signals between an electrical circuit with a first common reference and an electrical circuit with a second common reference, the system comprising:
a capacitively coupled signal line coupled between the first and second referenced electrical circuits to permit transfer of signals and high-voltage isolation between the first and second referenced electrical circuits;
a transmitter or receiver in the first referenced electrical circuit and coupled to the signal line to send or receive a signal, respectively;
a receiver or transmitter in the second referenced electrical circuit and coupled to the signal line to receive or send a signal, respectively, in conjunction with the transmitter or receiver of the first referenced electrical circuit; and
an impedance coupled to the signal line and operable to be configured to compensate capacitive values in the capacitively coupled signal line.

2. The system according to claim 1, wherein the impedance further comprises a variable impedance.

3. The system according to claim 1, wherein the impedance further comprises a programmable impedance.

4. The system according to claim 1, further comprising a parameter storage device for storing a parameter to influence a value of the impedance.

5. The system according to claim 4, wherein the impedance further comprises a programmable impedance, the parameter storage device providing a parameter value to contribute to programming a value of the impedance.

6. A bi-directional communication link between electrically isolated devices, comprising:
bi-directional transceivers coupled to each end of the communication link;
a capacitive value associated with each signal path in the bi-directional communication link;
one or more compensation impedances coupled to one or more signal paths of the bi-directional communication link; and
the one or more compensation impedances having a value to compensate for mismatches in the capacitive values to obtain balanced signal paths in the bi-directional communication link.

7. The communication link according to claim 6, further comprising a value of the one or more impedances being set to optimize a Common Mode Rejection Ratio (CMRR) of the bi-directional communication link.

8. The communication link according to claim 6, further comprising a capacitive coupling between the transceivers to realize the bi-directional communication link, the capacitive coupling providing a high-voltage isolation between the electrically isolated devices.

9. The communication link according to claim 8, wherein the capacitance for the capacitive coupling is formed with circuit board traces coupled to the electrically isolated devices.

10. The communication link according to claim 8, wherein the capacitance for the capacitive coupling is formed with lead frames associated with the electrically isolated devices.

11. The communication link according to claim 8, wherein the capacitance for the capacitive coupling is formed with a molding compound at least partially covering the communication link.

12. The communication link according to claim 8, wherein the capacitance for the capacitive coupling is formed with discrete capacitors.

13. The communication link according to claim 6, further comprising a parameter storage device for holding parameter values that can influence the compensation impedances to obtain the balanced signal paths.

14. The communication link according to claim 13, wherein the storage device is digital.

15. The communication link according to claim 13, wherein the storage device is analog.

16. A method for communicating a signal across a high-voltage isolation barrier, comprising:
providing a capacitively coupled communication link between the two electrically isolated devices;
compensating one or more capacitive values in the capacitively coupled communication link;
tuning the compensation to optimize CMRR.

17. The method according to claim 16, wherein tuning further comprises:
developing a voltage across the capacitively coupled communication link; and
adjusting an impedance coupled to the capacitively coupled communication link to nullify voltage mismatches.

18. The method according to claim 17, further comprising implementing tuning one time to adjust the impedance.

19. The method according to claim 17, further comprising implementing tuning at predetermined intervals or upon predetermined events.

20. The method according to claim 17, further comprising implementing tuning on a continuous basis.

21. The method according to claim 16, further comprising storing a parameter value related to tuning to contribute to compensating the one or more capacitive values at a later time.

22. The system according to claim 1, wherein the system is encapsulated in an integrated circuit (IC) package.

23. The communication link according to claim 6, wherein the communication link and electrically isolated devices are contained within an IC package.
